(19) United States
(12) Patent Application Publication
(10) Pub. No.: US 2024/0420515 A1
(43) Pub. Date: Dec. 19, 2024

(54) ADVANCED DRIVER ASSISTANCE SYSTEMS SENSOR RING NETWORK

(71) Applicant: TORC Robotics, Inc., Blacksburg, VA (US)

(72) Inventors: Dennis KING, Blacksburg, VA (US); Andrew CUNNINGHAM, Blacksburg, VA (US); John BLANKENHORN, Blacksburg, VA (US); Adam SHOEMAKER, Blacksburg, VA (US); Bodo SEIFERT, Blacksburg, VA (US)

(73) Assignee: TORC Robotics, Inc., Blacksburg, VA (US)

(21) Appl. No.: 18/335,457

(22) Filed: Jun. 15, 2023

(51) Int. Cl. G07C 5/00; B60R 16/023; H04L 12/42

(52) U.S. Cl. CPC G07C 5/008; B60R 16/023; H04L 12/42

(57) ABSTRACT

Autonomous vehicles including sensors and electronic control units (ECUs) that communicate via ring networks are disclosed. A system includes an ECU of an autonomous vehicle that includes an ECU network interface. The system includes a plurality of sensors disposed on the autonomous vehicle, and each of the plurality of sensors includes a respective sensor network interface. The system includes a plurality of network links communicatively coupling the plurality of sensors to the ECU network interface of the ECU via the respective sensor network interface in a ring configuration.

### TECHNICAL FIELD

The present disclosure relates generally to autonomous vehicles and, more specifically, to network topologies via which devices of an autonomous vehicle communicate.

### BACKGROUND

The use of autonomous vehicles has become increasingly prevalent in recent years, with the potential for numerous benefits. Advanced Driver Assistance Systems (ADAS) rely on sensor data from many sensors positioned within and mounted on an autonomous vehicle to operate. Sensors can communicate with systems of an autonomous vehicle via an electronic control unit (ECU). In autonomous vehicles, multiple sensors are often connected to a single ECU. Multiple ECUs may be present on a single autonomous vehicle, each serving their own set of sensors.

However, as more and more ADAS features (and therefore sensors or devices) are added to autonomous vehicles, the complexity of the ECU network topology increases. This can result in issues such as data congestion, reduced reliability, and increased latency, all of which can impact the performance of ADAS systems. Additionally, the increased complexity of such networks makes upgrades or changes to the configuration of autonomous vehicles challenging.

### SUMMARY

The systems and methods of the present disclosure may solve the problems set forth above and/or other problems in the art. The scope of the current disclosure, however, is defined by the attached claims, and not by the ability to solve any specific problem. Disclosed herein are techniques to improve sensor networks that reduce data congestion, increase reliability, and reduce latency. Additionally, the ring-based sensor networks described herein provide redundancy, such that autonomous vehicle systems can still operate when one or more devices in the ring-based sensor network fails.

One embodiment of the present disclosure is directed to a system. The system includes an electronic control unit (ECU) of an autonomous vehicle comprising an ECU network interface; a plurality of sensors disposed on the autonomous vehicle, each of the plurality of sensors comprising a respective sensor network interface; and a plurality of network links communicatively coupling the plurality of sensors to the ECU network interface of the ECU via the respective sensor network interface in a ring configuration.

The ECU network interface of the ECU may comprise at least two connections to the plurality of network links. The ring configuration may further comprise a second ECU of the autonomous vehicle. The system may comprise a plurality of second sensors communicatively coupled to a second network interface of the ECU via a plurality of second network links.

The plurality of network links may comprise an Ethernet link. The ring configuration may comprise a counter-rotating ring network. The plurality of sensors may comprise a camera, an inertial measurement unit (IMU), a global navigation satellite system (GNSS) receiver, a radar sensor, or a light detection and ranging (LiDAR) sensor. The system may comprise a second ECU communicatively coupled to a plurality of second sensors communicatively coupled to a second network interface of the ECU via a plurality of second network links, the second ECU in communication with the ECU via the second network interface of the ECU.

Another embodiment of the present disclosure is directed to an autonomous vehicle. The autonomous vehicle includes a first plurality of sensors and a second plurality of sensors disposed on the autonomous vehicle; and an electronic control unit (ECU) receiving sensor data from the first and second plurality of sensors. The first plurality of sensors is communicatively coupled to the ECU via a first ring network configuration, and the second plurality of sensors is communicatively coupled to the ECU via a second ring network configuration.

The first plurality of sensors may communicate via the first ring network configuration via a plurality of Ethernet links. The first plurality of sensors may comprise a camera, an IMU, a GNSS receiver, a radar sensor, or a LiDAR sensor. The ECU may be a first ECU, and the autonomous vehicle may further comprise a second ECU communicatively coupled to the first ECU via a third network interface.

The second ECU may be configured to process data communicated to the first ECU upon detecting a failure of the first ECU. The second ECU may be further configured to detect the failure of the first ECU responsive to failing to communicate with the first ECU for a predetermined amount of time. The second ECU may be configured to receive and perform redundant processing of data communicated to the ECU.

The ECU may be further configured to receive, via the first ring network configuration, first sensor data generated by the first plurality of sensors; and control one or more operations of the autonomous vehicle based on the sensor data. The first plurality of sensors may be further configured to transmit multicast data via the first ring network configuration.

Yet another embodiment of the present disclosure is directed to a method. The method may be performed by an autonomous vehicle system. The method includes capturing sensor data from at least one sensor disposed on an autonomous vehicle; transmitting the sensor data to at least two devices via a ring network configuration in communication with the at least one ECU; and processing the sensor data using the at least one ECU.

The at least one sensor may comprise a camera, an IMU, a GNSS receiver, a radar sensor, or a LiDAR sensor. The ring network configuration may comprise a counter-rotating ring network.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a bird's eye view of a roadway including a schematic representation of a vehicle and aspects of an autonomy system of the vehicle, according to an embodiment.

FIG. 2 is a schematic of the autonomy system of the vehicle, according to an embodiment.

FIG. 3 is a block diagram of an example ring network including an ECU and multiple sensors, according to an embodiment.

FIG. 4 is a block diagram of an example ring network including multiple ECUs and multiple sensors, according to an embodiment.

FIG. 5 is a block diagram of an example network in which sensors communicate with an ECU via multiple ring network configurations, according to an embodiment.

FIG. 6 is a block diagram of an example network in which multiple sensors and multiple ECUs communicate via multiple ring network configurations, according to an embodiment.

FIG. 7 is a flow diagram of an example method of utilizing the ring network configurations described herein during autonomous vehicle operation, according to an embodiment.

### DETAILED DESCRIPTION

The following detailed description describes various features and functions of the disclosed systems and methods with reference to the accompanying figures. In the figures, similar components are identified using similar symbols, unless otherwise contextually dictated. The exemplary system(s) and method(s) described herein are not limiting, and it may be readily understood that certain aspects of the disclosed systems and methods can be variously arranged and combined, all of which arrangements and combinations are contemplated by this disclosure.

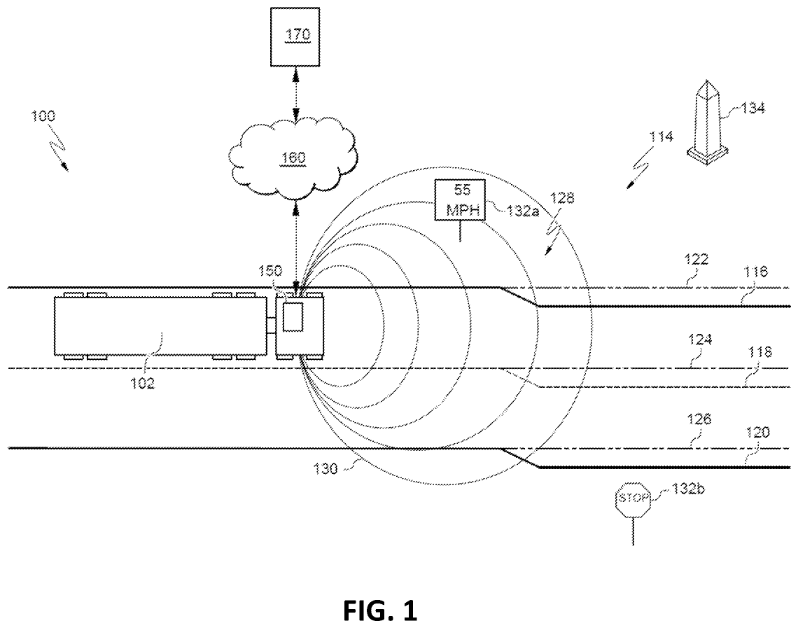

Referring to FIG. 1, the present disclosure relates to autonomous vehicles, such as an autonomous truck 102 having an autonomy system 150. The autonomy system 150 of truck 102 may be completely autonomous (fully-autonomous), such as self-driving, driverless, or Level 4 autonomy, or semi-autonomous, such as Level 3 autonomy. As used herein the term “autonomous” includes both fully-autonomous and semi-autonomous. The present disclosure sometimes refers to autonomous vehicles as ego vehicles. The autonomy system 150 may be structured on at least three aspects of technology: (1) perception, (2) maps/localization, and (3) behaviors, planning and control. The function of the perception aspect is to sense an environment surrounding truck 102 and interpret it. To interpret the surrounding environment, a perception module or engine in the autonomy system 150 of the truck 102 may identify and classify objects or groups of objects in the environment. For example, a perception module associated with various sensors (e.g., LiDAR, camera, radar, etc.) of the autonomy system 150 may identify one or more objects (e.g., pedestrians, vehicles, debris, etc.) and features of the roadway (e.g., lane lines) around truck 102, and classify the objects in the road distinctly.

The maps/localization aspect of the autonomy system 150 may be configured to determine where on a pre-established digital map the truck 102 is currently located. One way to do this is to sense the environment surrounding the truck 102 (e.g., via the perception system) and to correlate features of the sensed environment with details (e.g., digital representations of the features of the sensed environment) on the digital map.

Once the systems on the truck 102 have determined its location with respect to the digital map features (e.g., location on the roadway, upcoming intersections, road signs, etc.), the truck 102 can plan and execute maneuvers and/or routes with respect to the features of the digital map. The behaviors, planning, and control aspects of the autonomy system 150 may be configured to make decisions about how the truck 102 should move through the environment to get to its goal or destination. It may consume information from the perception and maps/localization modules to know where it is relative to the surrounding environment and what other objects and traffic actors are doing.

FIG. 1 further illustrates an environment 100 for modifying one or more actions of truck 102 using the autonomy system 150. The truck 102 is capable of communicatively coupling to a remote server 170 via a network 160. The truck 102 may not necessarily connect with the network 160 or server 170 while it is in operation (e.g., driving down the roadway). That is, the server 170 may be remote from the vehicle, and the truck 102 may deploy with all the necessary perception, localization, and vehicle control software and data necessary to complete its mission fully-autonomously or semi-autonomously.

While this disclosure refers to a truck (e.g., a tractor trailer) 102 as the autonomous vehicle, it is understood that the truck 102 could be any type of vehicle including an automobile, a mobile industrial machine, etc. While the disclosure will discuss a self-driving or driverless autonomous system, it is understood that the autonomous system could alternatively be semi-autonomous, having varying degrees of autonomy or autonomous functionality.

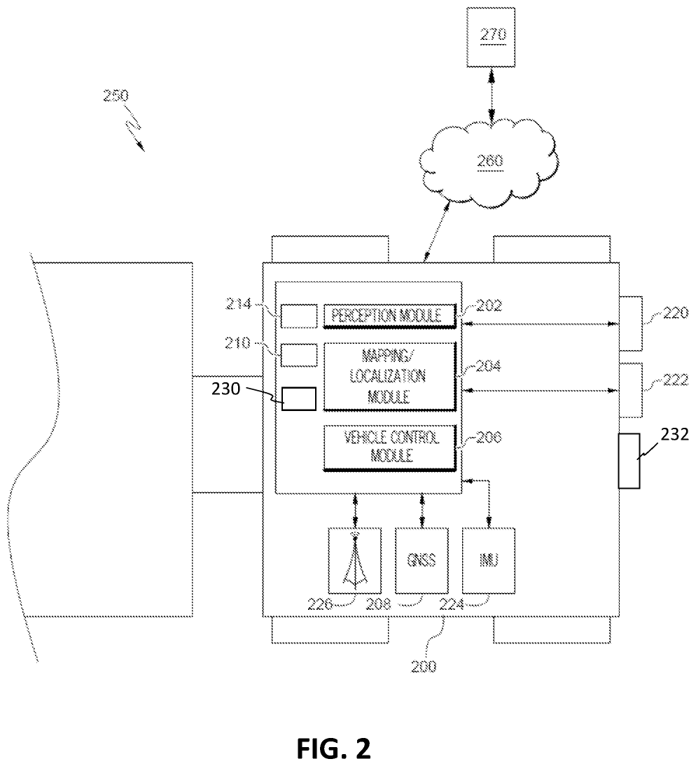

With reference to FIG. 2, an autonomy system 250 of a truck 200 (e.g., which may be similar to the truck 102 of FIG. 1) may include a perception system including a camera system 220, a LiDAR system 222, a radar system 232, a global navigation satellite system (GNSS) receiver 208, an inertial measurement unit (IMU) 224, and/or a perception module 202. The autonomy system 250 may further include a transceiver 226, a processor 210, a memory 214, a mapping/localization module 204, and a vehicle control module 206. The various systems may serve as inputs to and receive outputs from various other components of the autonomy system 250. In other examples, the autonomy system 250 may include more, fewer, or different components or systems, and each of the components or system(s) may include more, fewer, or different components. Additionally, the systems and components shown may be combined or divided in various ways. As shown in FIG. 1, the perception systems aboard the autonomous vehicle may help the truck 102 perceive its environment out to a perception radius 130. The actions of the truck 102 may depend on the extent of perception radius 130.

The camera system 220 of the perception system may include one or more cameras mounted at any location on the truck 102, which may be configured to capture images of the environment surrounding the truck 102 in any aspect or field of view (FOV). The FOV can have any angle or aspect such that images of the areas ahead of, to the side, and behind the truck 102 may be captured. In some embodiments, the FOV may be limited to particular areas around the truck 102 (e.g., ahead of the truck 102) or may surround 360 degrees of the truck 102. In some embodiments, the image data generated by the camera system(s) 220 may be sent to the perception module 202 and stored, for example, in memory 214.

The LiDAR system 222 may include a laser generator and a detector and can send and receive a LiDAR signals. The LiDAR signal can be emitted to and received from any direction such that LiDAR point clouds (or “LiDAR images”) of the areas ahead of, to the side, and behind the truck 200 can be captured and stored as LiDAR point clouds. In some embodiments, the truck 200 may include multiple LiDAR systems, and point cloud data from the multiple systems may be stitched together. In some embodiments, the system inputs from the camera system 220 and the LiDAR system 222 may be fused (e.g., in the perception module 202). The LiDAR system 222 may include one or more actuators to modify a position and/or orientation of the LiDAR system 222 or components thereof. The LIDAR system 222 may be configured to use ultraviolet (UV), visible, or infrared light to image objects and can be used with a wide range of targets. In some embodiments, the LiDAR system 222 can be used to map physical features of an object with high resolution (e.g., using a narrow laser beam). In some examples, the LiDAR system 222 may generate a point cloud, and the point cloud may be rendered to visualize the environment surrounding the truck 200 (or object(s) therein). In some embodiments, the point cloud may be rendered as one or more polygon(s) or mesh model(s) through, for example, surface reconstruction. Collectively, the LiDAR system 222 and the camera system 220 may be referred to herein as “imaging systems.”

The radar system 232 may estimate strength or effective mass of an object, as objects made out of paper or plastic may be weakly detected. The radar system 232 may be based on 24 GHZ, 77 GHz, or other frequency radio waves. The radar system 232 may include short-range radar (SRR), mid-range radar (MRR), or long-range radar (LRR). One or more sensors may emit radio waves, and a processor processes received reflected data (e.g., raw radar sensor data).

The GNSS receiver 208 may be positioned on the truck 200 and may be configured to determine a location of the truck 200 via GNSS data, as described herein. The GNSS receiver 208 may be configured to receive one or more signals from a global navigation satellite system (e.g., a global positioning system (GPS), etc.) to localize the truck 200 via geolocation. The GNSS receiver 208 may provide an input to and otherwise communicate with mapping/localization module 204 to, for example, provide location data for use with one or more digital maps, such as an HD map (e.g., in a vector layer, in a raster layer or other semantic map, etc.). In some embodiments, the GNSS receiver 208 may be configured to receive updates from an external network.

The IMU 224 may be an electronic device that measures and reports one or more features regarding the motion of the truck 200. For example, the IMU 224 may measure a velocity, acceleration, angular rate, and or an orientation of the truck 200 or one or more of its individual components using a combination of accelerometers, gyroscopes, and/or magnetometers. The IMU 224 may detect linear acceleration using one or more accelerometers and rotational rate using one or more gyroscopes. In some embodiments, the IMU 224 may be communicatively coupled to the GNSS receiver 208 and/or the mapping/localization module 204, to help determine a real-time location of the truck 200, and predict a location of the truck 200 even when the GNSS receiver 208 cannot receive satellite signals.

The transceiver 226 may be configured to communicate with one or more external networks 260 via, for example, a wired or wireless connection in order to send and receive information (e.g., to a remote server 270). The wireless connection may be a wireless communication signal (e.g., Wi-Fi, cellular, LTE, 5G, etc.) In some embodiments, the transceiver 226 may be configured to communicate with external network(s) via a wired connection, such as, for example, during initial installation, testing, or service of the autonomy system 250 of the truck 200. A wired/wireless connection may be used to download and install various lines of code in the form of digital files (e.g., HD digital maps), executable programs (e.g., navigation programs), and other computer-readable code that may be used by the system 250 to navigate the truck 200 or otherwise operate the truck 200, either fully-autonomously or semi-autonomously. The digital files, executable programs, and other computer readable code may be stored locally or remotely and may be routinely updated (e.g., automatically or manually) via the transceiver 226 or updated on demand.

In some embodiments, the truck 200 may not be in constant communication with the network 260, and updates which would otherwise be sent from the network 260 to the truck 200 may be stored at the network 260 until such time as the network connection is restored. In some embodiments, the truck 200 may deploy with all of the data and software it needs to complete a mission (e.g., necessary perception, localization, and mission planning data) and may not utilize any connection to network 260 during some or the entire mission. Additionally, the truck 200 may send updates to the network 260 (e.g., regarding unknown or newly detected features in the environment as detected by perception systems) using the transceiver 226. For example, when the truck 200 detects differences between the perceived environment and the features on a digital map, the truck 200 may provide updates to the network 260 with information, as described in greater detail herein.

In some embodiments, the truck 200 can include one or more ECU(s) 230. The one or more ECU(s) 230 may include processors, microcontrollers, memories, or other computing devices that can be utilized to control various functions within the truck 200. For example, the one or more ECU(s) 230 can be utilized to process, manage, and communicate data from various sources, including sensors, cameras, and other control systems present on the truck 200. Some example sensors that may be in communication with the one or more ECU(s) 230 include the camera system 220, the LiDAR system 222, the radar system 232, the GNSS receiver 208, the IMU 224, and the perception module 202, as well as the processor 210 or other components of the autonomy system 250.

The one or more ECU(s) 230 can collect various sensor data from the sensors and other devices disposed on the truck 200. In some embodiments, the one or more ECU(s) 230 may process the sensor data or utilize the sensor data to control the truck 200. For example, an ECU 230 can use the data from sensors to identify objects and obstacles in the environment, such as other vehicles, pedestrians, and road signs. In an embodiment, an ECU 230 can control how the truck 200 responds to the environment by controlling one or more operational devices or features of the truck. For example, an ECU 230 may communicate with one or more other devices of the truck 200 to adjust the speed of the truck 200, initiate a lane change, or cause the truck 200 to avoid an obstacle, among other functionalities. To do so, in some embodiments, the ECU 230 can send commands to various control systems of the truck 200, such as the powertrain, steering, or brakes.

The processor 210 of autonomy system 250 may be embodied as one or more of a data processor, a microcontroller, a microprocessor, a digital signal processor, a logic circuit, a programmable logic array, or one or more other devices for controlling the autonomy system 250 in response to one or more of the system inputs. Autonomy system 250 may include a single microprocessor or multiple microprocessors that may include means for identifying and reacting to differences between features in the perceived environment and features of the maps stored on the truck. Numerous commercially available microprocessors can be configured to perform the functions of the autonomy system 250. It should be appreciated that the autonomy system 250 could include a general machine controller capable of controlling numerous other machine functions. Alternatively, a special-purpose machine controller could be provided. Further, the autonomy system 250, or portions thereof, may be located remotely from the system 250. For example, one or more features of the mapping/localization module 204 could be located remotely from the truck. Various other known circuits may be associated with the autonomy system 250, including signal-conditioning circuitry, communication circuitry, actuation circuitry, and other appropriate circuitry.

The memory 214 of autonomy system 250 may store data and/or software routines that may assist the autonomy system 250 in performing its functions, such as the functions of the perception module 202, the mapping/localization module 204, and the vehicle control module 206. The memory 214 may include processor executable instructions that enable communication with various sensors or devices of the autonomy system via one or more ring-based networks described herein. In an embodiment, the memory 214 can include instructions to communicate or receive information via the one or more one or more ECU(s) 230. Further, the memory 214 may also store data received from various inputs associated with the autonomy system 250, such as perception data from the perception system.

As noted above, perception module 202 may receive input (“perception data”) from the various sensors, such as camera system 220, LiDAR system 222, GNSS receiver 208, and/or IMU 224, (collectively “perception data”) to sense an environment surrounding the truck and interpret it. To interpret the surrounding environment, the perception module 202 (or “perception engine”) may identify and classify objects or groups of objects in the environment. For example, the truck 200 may use the perception module 202 to identify one or more objects (e.g., pedestrians, vehicles, debris, etc.) or features of the roadway 114 (e.g., intersections, road signs, lane lines, etc.) before or beside a vehicle and classify the objects in the road. In some embodiments, the perception module 202 may include an image classification function and/or a computer vision function. In some embodiments, the perception module 202 may include, communicate with, or otherwise utilize one or more of the ECU 230 to transmit commands to or receive data from sensors of the truck 200.

The system 100 may collect perception data. The perception data may represent the perceived environment surrounding the vehicle and may be collected using aspects of the perception system described herein. The perception data can come from, for example, one or more of the LiDAR system, the camera system, and various other externally-facing sensors and systems on board the vehicle (e.g., the GNSS receiver, etc.). For example, on vehicles having a sonar or radar system, the sonar and/or radar systems may collect perception data. As the truck 102 travels along the roadway 114, the system 100 may continually receive data from the various systems on the truck 102. In some embodiments, the system 100 may receive data periodically and/or continuously.

With respect to FIG. 1, the truck 102 may collect perception data that indicates presence of the lane lines 116, 118, 120. Features perceived by the vehicle should generally track with one or more features stored in a digital map (e.g., in the mapping/localization module 204). Indeed, with respect to FIG. 1, the lane lines that are detected before the truck 102 is capable of detecting the bend 128 in the road (that is, the lane lines that are detected and correlated with a known, mapped feature) will generally match with features in stored map and the vehicle will continue to operate in a normal fashion (e.g., driving forward in the left lane of the roadway or per other local road rules). However, in the depicted scenario, the vehicle approaches a new bend 128 in the road that is not stored in any of the digital maps on board the truck 102 because the lane lines 116, 118, 120 have shifted right from their original positions 122, 124, 126.

The system 100 may compare the collected perception data with stored data. For example, the system may identify and classify various features detected in the collected perception data from the environment with the features stored in a digital map. For example, the detection systems may detect the lane lines 116, 118, 120 and may compare the detected lane lines with lane lines stored in a digital map. Additionally, the detection systems could detect the road signs 132a, 132b and the landmark 134 to compare such features with features in a digital map. The features may be stored as points (e.g., signs, small landmarks, etc.), lines (e.g., lane lines, road edges, etc.), or polygons (e.g., lakes, large landmarks, etc.) and may have various properties (e.g., style, visible range, refresh rate, etc.), which properties may control how the system 100 interacts with the various features. Based on the comparison of the detected features with the features stored in the digital map(s), the system may generate a confidence level, which may represent a confidence of the vehicle in its location with respect to the features on a digital map and hence, its actual location.

The image classification function may determine the features of an image (e.g., a visual image from the camera system 220 and/or a point cloud from the LiDAR system 222). The image classification function can be any combination of software agents and/or hardware modules able to identify image features and determine attributes of image parameters in order to classify portions, features, or attributes of an image. The image classification function may be embodied by a software module that may be communicatively coupled to a repository of images or image data (e.g., visual data and/or point cloud data) which may be used to detect and classify objects and/or features in real time image data captured by, for example, the camera system 220 and the LiDAR system 222. In some embodiments, the image classification function may be configured to detect and classify features based on information received from only a portion of the multiple available sources. For example, in the case that the captured visual camera data includes images that may be blurred, the system 250 may identify objects based on data from one or more of the other systems (e.g., LiDAR system 222) that does not include the image data.

The computer vision function may be configured to process and analyze images captured by the camera system 220 and/or the LiDAR system 222 or stored on one or more modules of the autonomy system 250 (e.g., in the memory 214), to identify objects and/or features in the environment surrounding the truck 200 (e.g., lane lines). The computer vision function may use, for example, an object recognition algorithm, video tracing, one or more photogrammetric range imaging techniques (e.g., a structure from motion (SfM) algorithms), or other computer vision techniques. The computer vision function may be configured to, for example, perform environmental mapping and/or track object vectors (e.g., speed and direction). In some embodiments, objects or features may be classified into various object classes using the image classification function, for instance, and the computer vision function may track the one or more classified objects to determine aspects of the classified object (e.g., aspects of its motion, size, etc.). The computer vision function may be embodied by a software module that may be communicatively coupled to a repository of images or image data (e.g., visual data and/or point cloud data), and may additionally implement the functionality of the image classification function.

Mapping/localization module 204 receives perception data that can be compared to one or more digital maps stored in the mapping/localization module 204 to determine where the truck 200 is in the world and/or or where the truck 200 is on the digital map(s). In particular, the mapping/localization module 204 may receive perception data from the perception module 202 and/or from the various sensors sensing the environment surrounding the truck 200 and may correlate features of the sensed environment with details (e.g., digital representations of the features of the sensed environment) on the digital maps. The digital map may have various levels of detail and can be, for example, a raster map, a vector map, etc. The digital maps may be stored locally on the truck 200 and/or stored and accessed remotely. In at least one embodiment, the truck 200 deploys with sufficiently stored information in one or more digital map files to complete a mission without connecting to an external network during the mission. A centralized mapping system may be accessible via network 260 for updating the digital map(s) of the mapping/localization module 204. The digital map may be built through repeated observations of the operating environment using the truck 200 and/or trucks or other vehicles with similar functionality. For instance, the truck 200, a specialized mapping vehicle, a standard autonomous vehicle, or another vehicle can run a route several times and collect the location of all targeted map features relative to the position of the vehicle conducting the map generation and correlation. These repeated observations can be averaged together in a known way to produce a highly accurate, high-fidelity digital map. This generated digital map can be provided to each vehicle (e.g., from the network 260 to the truck 200) before the vehicle departs on its mission so it can carry it on board and use it within its mapping/localization module 204. Hence, the truck 200 and other vehicles (e.g., a fleet of trucks similar to the truck 200) can generate, maintain (e.g., update), and use their own generated maps when conducting a mission.

The generated digital map may include an assigned confidence score assigned to all or some of the individual digital features representing a feature in the real world. The confidence score may be meant to express the level of confidence that the position of the element reflects the real-time position of that element in the current physical environment. Upon map creation, after appropriate verification of the map (e.g., running a similar route multiple times such that a given feature is detected, classified, and localized multiple times), the confidence score of each element will be very high, possibly the highest possible score within permissible bounds.

The vehicle control module 206 may control the behavior and maneuvers of the truck. For example, once the systems on the truck have determined its location with respect to map features (e.g., intersections, road signs, lane lines, etc.) the truck may use the vehicle control module 206 and its associated systems to plan and execute maneuvers and/or routes with respect to the features of the environment. The vehicle control module 206 may make decisions about how the truck will move through the environment to get to its goal or destination as it completes its mission. The vehicle control module 206 may consume information from the perception module 202 and the maps/localization module 204 to know where it is relative to the surrounding environment and what other traffic actors are doing.

The vehicle control module 206 may be communicatively and operatively coupled to a plurality of vehicle operating systems and may execute one or more control signals and/or schemes to control operation of the one or more operating systems, for example, the vehicle control module 206 may control one or more of a vehicle steering system, a propulsion system, and/or a braking system. The propulsion system may be configured to provide powered motion for the truck and may include, for example, an engine/motor, an energy source, a transmission, and wheels/tires. The propulsion system may be coupled to and receive a signal from a throttle system, for example, which may be any combination of mechanisms configured to control the operating speed and acceleration of the engine/motor and, thus, the speed/acceleration of the truck. The steering system may be any combination of mechanisms configured to adjust the heading or direction of the truck. The brake system may be, for example, any combination of mechanisms configured to decelerate the truck (e.g., friction braking system, regenerative braking system, etc.). The vehicle control module 206 may be configured to avoid obstacles in the environment surrounding the truck and use one or more system inputs to identify, evaluate, and modify a vehicle trajectory. The vehicle control module 206 is depicted as a single module, but can be any combination of software agents and/or hardware modules capable of generating vehicle control signals operative to monitor systems and controlling various vehicle actuators. The vehicle control module 206 may include a steering controller for vehicle lateral motion control and a propulsion and braking controller for vehicle longitudinal motion.

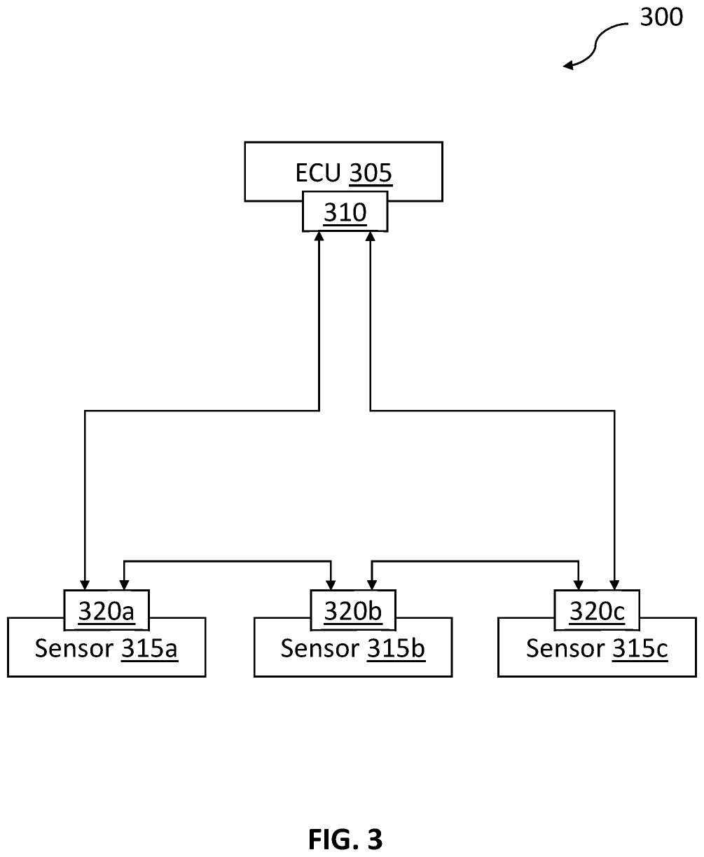

FIG. 3 is a block diagram 300 of an example ring network including an ECU 305 and multiple sensors 315a-c (sometimes individually referred to as a “sensor 315” or collectively as the “sensors 315”), according to an embodiment. The ECU 305 may be similar to, and implement any of the structure and functionality of, the ECU 230 described in connection with FIG. 2. The ECU 305 can include processors, microcontrollers, memories, or other computing devices that can be utilized to gather sensor data, perform processing operations, and control various aspects or operations of an autonomous vehicle.

In some embodiments of autonomous vehicles that do not implement the techniques described herein, an ECU may communicate with sensors, for example, using a star network topology. In a star network topology, each device is connected to a single central hub or switch, which can act as a central point of communication, and all data transmission in the network must pass through it. Each device that communicates via the star network topology can utilize its own dedicated point-to-point connection to the central hub. However, when utilized in autonomous vehicles, star network topologies introduce a number of challenges. For example, when utilizing a star network topology, each cable must be modeled for length and routing through the vehicle, making component replacement more costly and challenging.

Additionally, if an ECU acts as the central hub or switch, the ECU itself must have many connections, or many additional ECUs will then be required, which introduces software complexity to manage communications in the autonomous vehicle. Further, if the central ECU fails, then all sensors are lost to the other systems of the autonomous vehicle. This can require halting autonomous vehicle operation to prevent accidents or other failures. The centralized nature of such approaches further requires that only one ECU be able to process data received by a sensor, unless the ECU itself distributes the data through additional network components, overall increasing system complexity.

To address these and other issues, the ECU 305 can utilize ECU network interface 310 to communicate with the sensors 315 using a ring topology. To communicate via a ring topology, the ECU 305 can utilize an ECU network interface 310. The ECU network interface 310 can include multiple ports that enable communication with multiple devices (e.g., the sensors 315). The ECU network interface 310 may be an Ethernet interface, a serial interface, or another type of wired communication interface. In the example shown in the diagram 300, the ECU 305 includes an ECU network interface 310 with two ports that are communicatively coupled with sensors, as described in further detail herein. In an embodiment, the ECU network interface 310 may include more than, or fewer than, two ports. The ECU network interface 310 can receive information from one or more devices via the ports, and provide the received data to the processing components of the ECU 305. Additionally, the ECU network interface 310 can receive information from the processing components of the ECU 305 to transmit via the ports to other devices that are communicatively coupled to the ECU network interface 310.

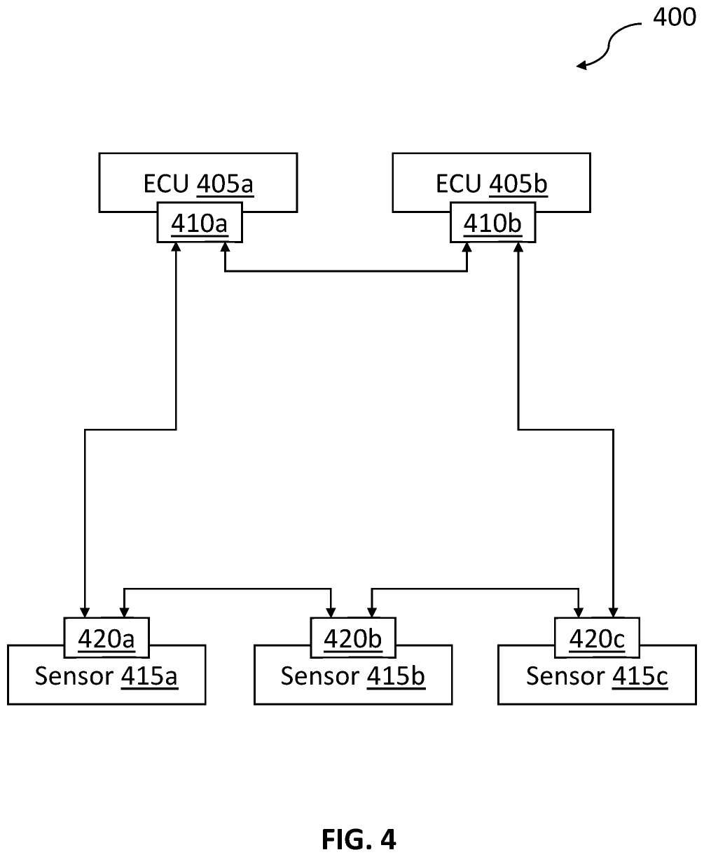

The ECU network interface 310 can implement a counter-rotating ring network (e.g., a counter-rotating Ethernet network or another type of suitable protocol, etc.). As shown, the counter-rotating ring network uses a ring configuration. In a counter-rotating ring network, data is transmitted in two opposite directions. Transmitting data in two directions provides redundancy and high availability, because in the event that a component of the ring network fails (e.g., a sensor 315), a backup path for data transmission still exists in at least one direction. In a counter-rotating ring network, each device (e.g., the ECU 305, the sensors 315) in the network is connected to at least two other devices, forming one or more closed loops. Example embodiments showing additional ring-based configurations are described in connection with FIGS. 4-6. In the example network configuration shown in the diagram 300, data can be transmitted by the ECU network interface 310 in opposite directions around the ring, allowing multiple paths for data transmission. If one path is blocked or fails, the ECU network interface 310 can transmit said data in the opposite direction, enabling the information to reach its destination even in the event of a failed component.

To implement a ring network, each of the sensors 315ac can include a respective sensor network interface 320a-c (sometimes individually referred to as a “sensor network interface 320” or collectively as the “sensor network interfaces 320”). Each of the sensors 315a-c can be any type of sensor described herein, including any of the components of the camera system 220, the LiDAR system 222, the radar system 232, the GNSS receiver 208, the IMU 224, and the perception module 202 of FIG. 2, among other sensors or processing components or devices described herein. The sensor network interfaces 320 can be similar to the ECU network interface 310. The sensor network interfaces 320 can each include multiple ports that enable communication with multiple devices (e.g., the sensors 315, the ECU 305). The sensor network interfaces 320 may be an Ethernet interface, a serial interface, or another type of wired communication interface. In an embodiment, one or more of the sensor network interfaces 320 may include more than, or fewer than, two ports. The sensor network interfaces 320 can transmit sensor information, commands, or other data to other devices in the ring network configuration via the ports. Each sensor network interface can receive respective sensor data from its respective sensor 315, and can transmit the sensor data via the ring network topology.

The sensor network interfaces 320 and the ECU network interface 310 can transmit data in two opposite directions. In an embodiment, each of the sensor network interfaces 320 and the ECU network interface 310 can forward that data to each next device in the ring configuration (e.g., a “hop”), such that information can reach any device in the ring network. The sensor network interfaces 320 can transmit data in two opposite directions in the ring configuration, as described herein to implement a counter-rotating ring network. Each of the sensor network interfaces 320 and the ECU network interface 310 may implement hardware, including field-programmable gate arrays (FPGAs), application-specific integrated circuits (ASICs), or other circuitry to automatically forward or discard data traversing the ring network with minimal latency.

Data can be forwarded through the devices in the ring network via a “cut-through” method to minimize latency. When implementing the cut-through method, the sensor network interfaces 320 (or the ECU network interface 310) can read the destination address of an incoming packet and immediately begin forwarding the packet to the appropriate output port. The respective interface (e.g., the sensor network interface 320 or the ECU interface 310) can utilize the information contained in the packet (e.g., a destination address) or information relating to the port of the interface that received the packet to forward the packet to an appropriate destination. Once transmitted data has traversed the ring in both directions, the packet can be terminated (e.g., dropped, deleted, etc.). Any suitable protocol may be utilized to forward data within the ring network, including the high-availability seamless redundancy (HSR) protocol. The HSR protocol is a network protocol for Ethernet that provides seamless failover against failure of any single network component.

In this example, the sensor network interface 320a of the sensor 315a is communicatively coupled to the ECU network interface 310 of the ECU 305 via one port, and communicatively coupled to the sensor network interface 320b of the sensor 315b via another port. Similarly, the sensor network interface 320c of the sensor 315c is communicatively coupled to the ECU network interface 310 of the ECU 305 via one port, and communicatively coupled to the sensor network interface 320b of the sensor 315b via another port. The ports of the devices (e.g., the ECU 305, the sensors 315) shown in the diagram 300 may be communicatively coupled to other devices in the diagram 300 via physical network links (e.g., Ethernet cables, serial bus wires, etc.).

In a non-limiting example of the functionality of the counter-rotating ring network, sensor data gathered by the sensor 315b can be transmitted in two directions in the ring configuration via the sensor network interface 320b (e.g., to the sensor network interface 320a and to the sensor network interface 320c). Both the sensor network interface 320a and the sensor network interface 320c, upon receiving the sensor data, can forward the sensor data to the ECU network interface 310 via their corresponding second ports. The ECU network interface 310 can receive the sensor data and provide the data to the ECU 305. In some embodiments, either the ECU network interface 310 or the ECU 305 can handle the data redundancy by dropping or deleting the redundant data. In this non-limiting example, if the sensor 315a (or the sensor data interface 320a) were to fail, the sensor data of the sensor 315b could still reach the ECU 305 via the sensor network interface 320c, and the ECU 305 could still communicate with the remaining sensors 315b, 315c in the ring network.

In addition to redundancy, utilizing a counter-rotating ring network topology, such as the topology shown in the diagram 300, provides a number of advantages. For example, each cable can simply be modeled to connect an additional device to each next-closest device in the ring configuration, reducing the overall required length of cable compared to a star topology. The ring configuration further enables efficient addition of new devices to the ring network, because a new device can be inserted between two other devices in the ring topology without complex routing to the ECU (or one or more other destination devices).

The ring topology further reduces the number of network connections to the ECU 305 to enable communication with multiple sensors 315. Regardless of the number of sensors 315, the ECU 305 can utilize at least two ports to communicate via the ring network. The reduced number of connections and hardware components reduces software complexity. Although one ECU 305 and three sensors 315 are shown in the diagram 300, it should be understood that any number of ECUs 305, ECU network interfaces 310, sensors 315, or sensor network interfaces 320 may be present in a ring network configuration. The network links between the devices in the diagram 300 may be implemented, for example, using Ethernet that is capable of 1 Gbps transmission speed, or higher. Further examples of ring configurations are shown in FIGS. 4-6.

FIG. 4 illustrates a block diagram 400 of an example ring network including multiple ECUs 405a-b and multiple sensors 415a-c, according to an embodiment. Each of the ECUs 405a-b (individually or collectively the “ECU(s) 405”) can be similar to, and implement any of the structure and functionality of, the ECU 305 described in connection with FIG. 3. Each of the sensors 415a-c (individually or collectively the “sensor(s) 415”) can be similar to, and implement any of the structure and functionality of, the sensors 315a-c described in connection with FIG. 3. The ECUs 405a-b can each include respective ECU network interface 410a-b (individually or collectively the “ECU network interface(s) 410”), which can be similar to, and implement any of the structure and functionality of, the ECU network interface 310 described in connection with FIG. 3. Each of the sensors 415a-c can include respective sensor network interfaces 420a-c (individually or collectively the “sensor network interface(s) 420”), which can be similar to, and implement any of the structure and functionality of, the sensor network interfaces 320a-c described in connection with FIG. 3.

As shown in the example configuration shown in the diagram 400, two ECUs 405 can be communicatively coupled with multiple sensors 415 via the ECU network interfaces 410 and the sensor network interfaces 420. In some embodiments, data transmitted by the sensors 420 can be multicast data, such that each device that communicates via the ring network configuration can receive and process the data. Devices that cannot necessarily process the data (e.g., other sensors 415) can discard or forward the data along the ring network as described herein.

An example configuration such as the configuration shown in the diagram 400 may be implemented for ECU redundancy. In implementations where transmitted data is multicast, failure of a first ECU 405a does not prevent processing or transmission of sensor data through the system. This is because the second ECU 405b can still process and forward data in the ring configuration, by implementing the processing tasks of the ECU 405a. In some embodiments, the ECU 405b can detect failure of the ECU 405a (e.g., by receiving a failure message, by failing to communicate with the ECU 405a for a predetermined amount of time, failure to receive an acknowledgement packet, etc.) prior to performing the processing tasks of the ECU 405a. In some embodiments, the ECU 405a and the ECU 405b can perform sensor data processing simultaneously (e.g., performing the same tasks for redundancy, performing different tasks for parallel processing efficiency, etc.). In an embodiment, the ECUs 405 can be homogeneous or heterogeneous.

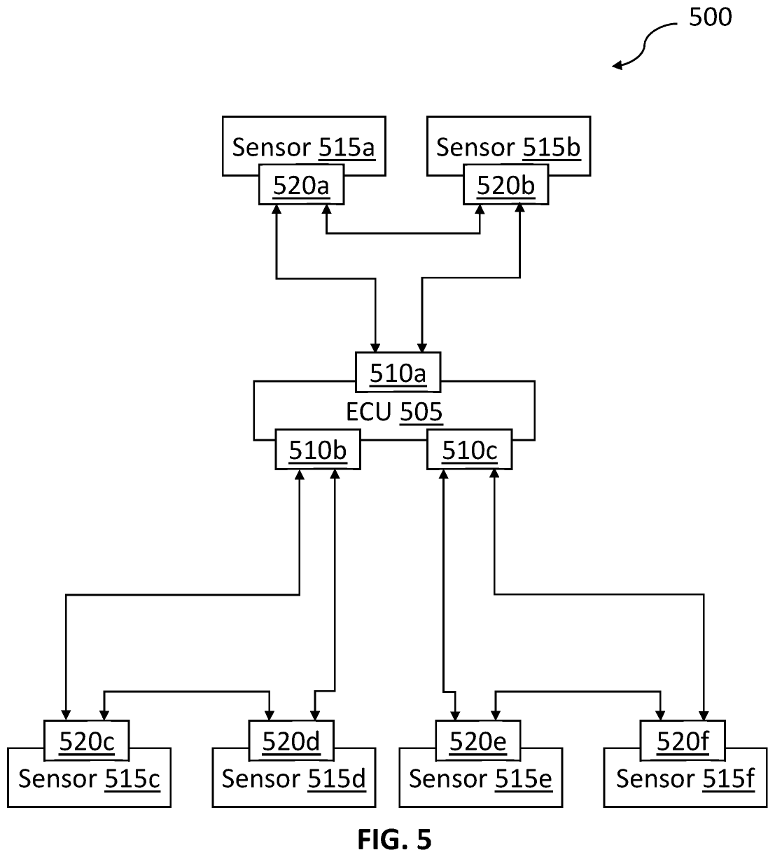

FIG. 5 is a block diagram 500 of an example network in which sensors 505a-f communicate with an ECU 505 via multiple ring network configurations, according to an embodiment. The ECU 505 can be similar to, and implement any of the structure and functionality of, the ECU 305 or the ECUs 405a-b described in connection with FIGS. 3 and 4. Each of the sensors 515a-f (individually or collectively the “sensor(s) 515”) can be similar to, and implement any of the structure and functionality of, the sensors 315a-c and the sensors 415a-c described in connection with FIGS. 3 and 4. The ECU 505 can include multiple ECU network interfaces 510a-c (individually or collectively the “ECU network interface(s) 510”), which can be similar to, and implement any of the structure and functionality of, the ECU network interface 310 and the ECU network interfaces 410a-b described in connection with FIGS. 3 and 4. Each of the sensors 415a-f can include respective sensor network interfaces 520a-f (individually or collectively the “sensor network interface(s) 520”), which can be similar to, and implement any of the structure and functionality of, the sensor network interfaces 320a-c and the sensor network interfaces 420a-c described in connection with FIGS. 3 and 4.

In the example configuration shown in the diagram 500, the ECU 505 includes multiple ECU interfaces 510, each of which implement a respective ring network topology. A first ring network includes the ECU 505, the sensor 515a, and the sensor 515b. A second ring includes the ECU 505, the sensor 515c, and the sensor 515d. A third ring includes the ECU 505, the sensor 515e, and the sensor 515f. In some embodiments, one or more ring networks can include sensors 515 that are disposed on or otherwise gather sensor data from respective regions of the autonomous vehicle (e.g., the truck 102, the truck 200, etc.). For example, the first ring network (e.g., including sensors 515a-b) can gather sensor data from a left side of the autonomous vehicle, the second ring network (e.g., including sensors 515c-d) can gather sensor data from a front side of the autonomous vehicle, and the third ring network (e.g., including sensors 515e-f) can gather sensor data from a right side of the autonomous vehicle.

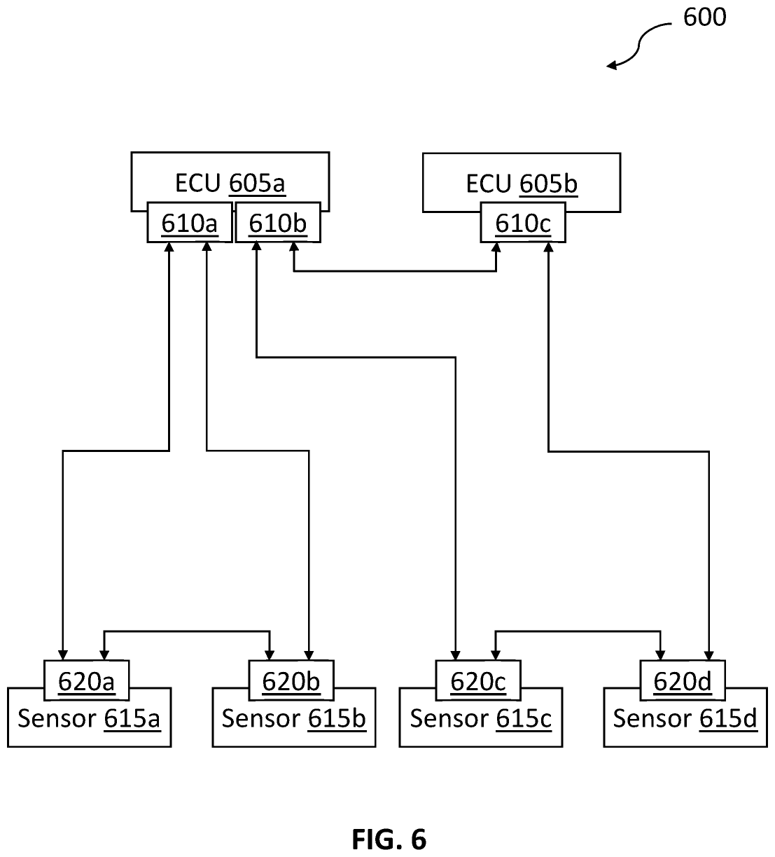

The use of multiple ECU network interfaces 510 can provide additional wiring flexibility and management of network load. For example, certain sensors 515 or ECUs 505, in particular applications, may utilize very low-latency data transmissions. Reducing the size of a ring network may reduce the latency from transmission to receipt by the destination device (e.g., the ECU 505). Therefore, in cases where lower-latency is preferable, fewer sensor devices 515 (or ECUs 505) can be included in a particular ring. Although each ring network configuration is shown here as including the ECU 505 and two sensors 515, it should be understood that any one ring network configuration can include any number of sensors 515 and any number of ECUs 505. Likewise, the ECU 505 may include any number of ECU network interfaces 510 to implement any number of ring configurations. Further details of multiple ring configurations with multiple ECUs are described in connection with FIG. 6.

FIG. 6 is a block diagram 600 of an example network in which multiple sensors 615a-d and multiple ECUs 605a-b communicate via multiple ring network configurations, according to an embodiment. The ECUs 605a-b (individually or collectively the “ECU(s) 605”) can be similar to, and implement any of the structure and functionality of, the ECU 305, the ECUs 405a-b, or the ECU 505 described in connection with FIGS. 3, 4, and 5. Each of the sensors 615a-d (individually or collectively the “sensor(s) 615”) can be similar to, and implement any of the structure and functionality of, the sensors 615a-c, the sensors 415a-c, and the sensors 515a-f described in connection with FIGS. 3, 4, and 5. The ECU 605a is shown as including multiple ECU network interfaces 610a-b, and the ECU 605b is shown as including an ECU interface 610c.

The ECU interfaces 610a-c may be individually or collectively referred to as the “ECU network interface(s) 610”, and can be similar to, and implement any of the structure and functionality of, the ECU network interface 310, the ECU network interfaces 410a-b, and the ECU network interfaces 510a-c described in connection with FIGS. 3, 4, and 5. Each of the sensors 615a-d can include respective sensor network interfaces 620a-d (individually or collectively the “sensor network interface(s) 620”), which can be similar to, and implement any of the structure and functionality of, the sensor network interfaces 320a-c, the sensor network interfaces 420a-c, and the sensor network interfaces 520a-f described in connection with FIGS. 3, 4, and 5.

In this example configuration, the ECU 605a includes two ECU network interfaces 610a-b, each of which correspond to a respective ring configuration. The first ring network configuration includes the ECU 605a, the sensor 615a, and the sensor 615b. The ring network configuration includes the ECU 605b, the sensor 615c, and the sensor 615d. The configuration shown in the diagram 600 can provide additional wiring flexibility and management of network load for certain sensors 615 as described herein, while also providing processing redundancy for the ECU 605b. For example, if the ECU 605b were to fail, the ECU 605a can receive sensor data generated by the sensors 615c-d, and perform the corresponding processing operations of the ECU 605b. In another example, if the ECU 605a were to fail, the ECU 605b can receive sensor data generated by the sensors 615c-d, and perform the corresponding processing operations of the ECU 605a with respect to the sensors 615c-d. In some embodiments, the ECU network interfaces 610a can transmit data to the ECU interface 605b, to transmit data between the first ring network configuration and the second ring network configuration, for example.

It should be understood that the foregoing ring network configuration can include any number of sensors 615 and any number of ECUs 605 in any arrangement or configuration to obtain useful results. For example, ECUs 605 and sensors 615 can be disposed in ring configurations to minimize latency, handle device failure, or to optimize cable routing, among other objectives. Each ECU 605 can include any number of ECU network interfaces 610. In some embodiments, a sensor 615 can include multiple sensor network interfaces 620, for example, to transmit sensor data via multiple network ring configurations. Although the foregoing description has utilized sensors as examples, it should be understood that the ECUs 605 or the sensors 615 may communicate via the ring network configurations described herein with any type of device that implements a suitable network interface.

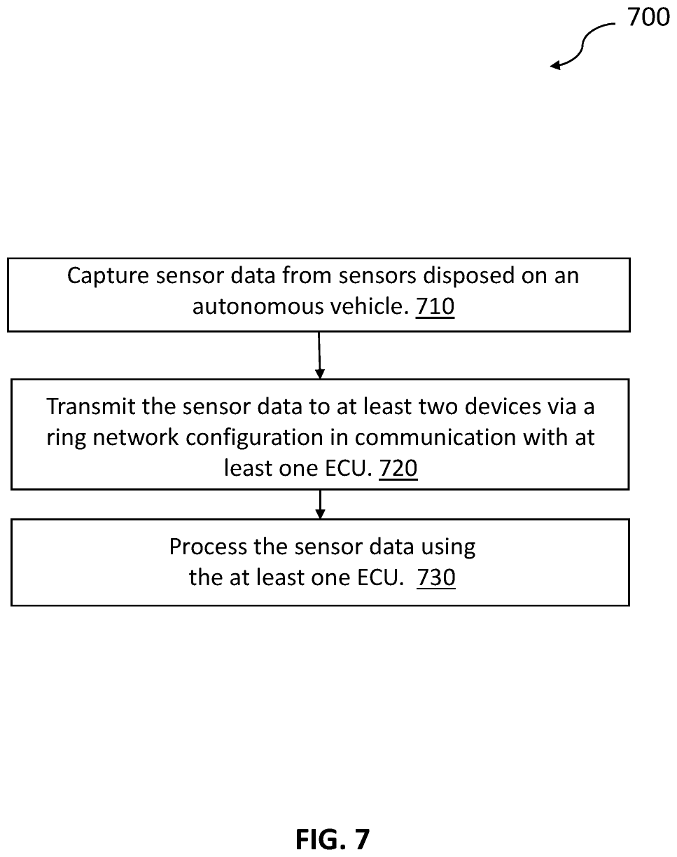

FIG. 7 is a flow diagram of an example method 700 of utilizing the ring network configurations described herein during autonomous vehicle operation, according to an embodiment. The steps of the method 700 of FIG. 7 may be executed, for example, by an autonomous vehicle system, including any autonomous vehicle implementing the various ring configurations described in connection with FIGS. 3-6, and including any such autonomous vehicle or component described in connection with the system 100, 250, according to some embodiments. The method 700 shown in FIG. 7 comprises execution steps 710-730. However, it should be appreciated that other embodiments may comprise additional or alternative execution steps, or may omit one or more steps altogether. It should also be appreciated that other embodiments may perform certain execution steps in a different order. Steps discussed herein may also be performed simultaneously or near-simultaneously with one another.

The method 700 of FIG. 7 is described as being performed by an autonomous vehicle system (e.g., the system 100, the system 250, including any of the network configurations shown in FIGS. 3-6). However, in some embodiments, one or more of the steps may be performed by different processor(s) or any other computing device.

Although the steps are shown in FIG. 7 having a particular order, it is intended that the steps may be performed in any order. It is also intended that some of these steps may be optional. The method 700 may be executed to utilize the various ring network configurations described herein to process sensor data.

At step 710, the autonomous vehicle system can capture sensor data from sensors (e.g., any of the components of the camera system 220, the LiDAR system 222, the radar system 232, the GNSS receiver 208, the IMU 224, and the perception module 202 of FIG. 2, etc.) disposed on an autonomous vehicle (e.g., the truck 102, the truck 200, etc.). Capturing sensor data can include capturing any data described herein during operation of the autonomous vehicle. In some implementations, the sensor data may be captured while the autonomous vehicle is not necessarily operating, such as during maintenance procedures or diagnostic tests.

At step 720, the autonomous vehicle system can transmit the sensor data to at least two devices via a ring network configuration (e.g., as shown in the diagrams 300, 400, 500, 600, etc.) in communication with at least one ECU (e.g., the ECU 230, 305, 405, 505, 605, etc.). The data can be transmitted, for example, by one or more sensor network interfaces (e.g., the sensor network interfaces 320, 420, 520, 620) or ECU network interfaces (e.g., the ECU network interfaces 310, 410, 510, 610) described herein, which may be in communication with the one or more sensors that captured the sensor data. The network interface(s) of the autonomous vehicle system can forward the sensor data to each next device in the ring configuration, such that information can reach any device in the ring network. The sensor data can be transmitted in two opposite directions in the ring configuration, as described herein, to implement a counter-rotating ring network.

The sensor data can be forwarded through the devices in the ring network via a cut-through method to minimize latency. To do so, each respective interface in the ring configuration that receives a packet or data frame can utilize the information contained in the packet or data frame (e.g., a destination address), or information relating to the port of the network interface that received the packet or data frame, to forward the packet or data frame to the appropriate destination in the ring configuration. Once the transmitted sensor data has traversed the ring in both directions, the packet or data frame can be terminated (e.g., dropped, deleted, etc.). Any suitable protocol may be utilized to forward data within the ring network, including the HSR protocol, which is a network protocol for Ethernet that provides seamless failover against failure of any single network component.

At step 730, the autonomous vehicle system can process the sensor data using the at least one ECU. As described herein, the ECUs of the autonomous vehicle system can include processors, microcontrollers, memories, or other computing devices that can be utilized to gather sensor data, perform processing operations, and control various aspects or operations of an autonomous vehicle. Using the sensor data received via the ring configuration, the ECU can perform any type of autonomous vehicle operation. For example, the ECU can utilize the sensor data to identify objects and obstacles in the environment, such as other vehicles, pedestrians, and road signs.

In an embodiment, the ECU can control how the autonomous vehicle responds to the environment by controlling one or more operational devices or features of the truck. For example, the ECU may communicate with one or more other devices of the autonomous vehicle to adjust the speed of the autonomous vehicle, initiate a lane change, or cause the autonomous vehicle to avoid an obstacle, among other functionalities. To do so, in some embodiments, the ECU can send commands to various control systems of the autonomous vehicle, such as the powertrain, steering, or brakes. The commands or messages provided by the ECU may be transmitted via one or more ring configurations, as described herein. For example, one ECU that processes sensor data may transmit commands, instructions, or data generated based on the sensor data to other ECUs in the autonomous vehicle system to control the autonomous vehicle.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various components, blocks, modules, circuits, and steps have been generally described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system, comprising:
an electronic control unit (ECU) of an autonomous vehicle comprising an ECU network interface;
a plurality of sensors disposed on the autonomous vehicle, each of the plurality of sensors comprising a respective sensor network interface; and
a plurality of network links communicatively coupling the plurality of sensors to the ECU network interface of the ECU via the respective sensor network interface in a ring configuration.

2. The system of claim 1, wherein the ECU network interface of the ECU comprises at least two connections to the plurality of network links.

3. The system of claim 1, wherein the ring configuration further comprises a second ECU of the autonomous vehicle.

4. The system of claim 1, further comprising a plurality of second sensors communicatively coupled to a second network interface of the ECU via a plurality of second network links.

5. The system of claim 1, wherein the plurality of network links comprises an Ethernet link.

6. The system of claim 1, wherein the ring configuration comprises a counter-rotating ring network.

7. The system of claim 1, wherein the plurality of sensors comprise a camera, an inertial measurement unit (IMU), a global navigation satellite system (GNSS) receiver, a radar sensor, or a light detection and ranging (LiDAR) sensor.

8. The system of claim 1, further comprising a second ECU communicatively coupled to a plurality of second sensors communicatively coupled to a second network interface of the ECU via a plurality of second network links, the second ECU in communication with the ECU via the second network interface of the ECU.

9. An autonomous vehicle, comprising:
a first plurality of sensors and a second plurality of sensors disposed on the autonomous vehicle; and
an electronic control unit (ECU) receiving sensor data from the first and second plurality of sensors,
wherein the first plurality of sensors is communicatively coupled to the ECU via a first network interface in a first ring network configuration, and the second plurality of sensors is communicatively coupled to the ECU via a second network interface in a second ring network configuration.

10. The autonomous vehicle of claim 9, wherein the first plurality of sensors communicate via the first ring network configuration via a plurality of Ethernet links.

11. The autonomous vehicle of claim 9, wherein the first plurality of sensors comprise a camera, an inertial measurement unit (IMU), a global navigation satellite system (GNSS) receiver, a radar sensor, or a light detection and ranging (LiDAR) sensor.

12. The autonomous vehicle of claim 9, wherein the ECU is a first ECU, the autonomous vehicle further comprising a second ECU communicatively coupled to the first ECU via a third network interface.

13. The autonomous vehicle of claim 12, wherein the second ECU is configured to process data communicated to the first ECU upon detecting a failure of the first ECU.

14. The autonomous vehicle of claim 13, wherein the second ECU is further configured to detect the failure of the first ECU responsive to failing to communicate with the first ECU for a predetermined amount of time.

15. The autonomous vehicle of claim 12, wherein the second ECU is configured to receive and perform redundant processing of data communicated to the ECU.

16. The autonomous vehicle of claim 9, wherein the ECU is further configured to:
receive, via the first ring network configuration, first sensor data generated by the first plurality of sensors; and
control one or more operations of the autonomous vehicle based on the sensor data.

17. The autonomous vehicle of claim 12, wherein the first plurality of sensors are further configured to transmit multicast data via the first ring network configuration.

18. A method, comprising:
capturing, by an autonomous vehicle system comprising at least one sensor and at least one electronic control unit (ECU), sensor data from the at least one sensor;
transmitting, by the autonomous vehicle system, the sensor data to at least two devices via a ring network configuration in communication with the at least one ECU; and
processing, by the autonomous vehicle system, the sensor data using the at least one ECU.

19. The method of claim 18, wherein the at least one sensor comprises a camera, an inertial measurement unit (IMU), a global navigation satellite system (GNSS) receiver, a radar sensor, or a light detection and ranging (LiDAR) sensor.

20. The method of claim 18, wherein the ring network configuration comprises a counter-rotating ring network.
